(19) United States
(12) Patent Application Publication
(10) Pub. No.: US 2003/0197991 A1
(43) Pub. Date: Oct. 23, 2003

(54) System for providing power to an electrical system in a vehicle

(75) Inventors: Gurinder Sing Kahlon, Canton, MI (US); Ning Liu, Novi, MI (US); Robert Joseph Mohan, Canton, MI (US)

Correspondence Address: BRINKS HOFER GILSON & LIONE, P.O. BOX 10395, CHICAGO, IL, 60611, US

(73) Assignee: Visteon Global Technologies, Inc.

(21) Appl. No.: 10/118,557

(22) Filed: Apr. 8, 2002

(51) Int. Cl. H02H 3/20

(52) U.S. Cl. 361/90

(57) ABSTRACT

The present invention provides in one embodiment a method of transferring power throughout a vehicle system. Voltage measurements from a capacitor bank are received. These measurements are compared with a threshold voltage. A determination is made if the measurements are less than the threshold voltage. Instructions are transmitted to a battery to supply power to a plurality of coils of an integrated starter generator (ISG) motor. The plurality of coils are analyzed to determine if the plurality of coils are energized. Power is transmitted from the plurality of coils to the capacitor bank, if the plurality of coils are energized.

### FIELD OF THE INVENTION

This invention relates generally to a system for providing power to a vehicle. More particularly, this invention relates to utilizing a controller to provide power to an electronic control system of the vehicle.

### BACKGROUND OF THE INVENTION

Typically, internal combustion engines used as motor vehicle power sources are normally started by a starter motor which comprises a DC motor. Electric power is supplied from a vehicle-mounted battery to the starter motor, which turns the crankshaft to start the engine.

An electrical current which is supplied from the battery to the starter motor when starting the engine is very high, e.g., 100 amps or more, though it is supplied in a short period of time. Therefore, the electric power consumption by the battery is quite large. The capacity of a battery to be installed on a motor vehicle is determined primarily in view of its ability to start the engine. The large amount of electric power that is consumed to start the engine is replenished when the battery is charged by electric power generated by the motor vehicle and driven by the engine while the vehicle is running.

Motor vehicles mainly used by commuters run over short distances, and motor vehicles used in delivery services are repeatedly stopped and started very frequently. Since these motor vehicles require the engines to be started frequently and are continuously driven over short periods of time, the batteries in these motor vehicles cannot be charged sufficiently enough to make up for the electric power consumed when the engines are started. Accordingly, the batteries tend to be depleted quickly, thus leading to some starting failures.

### SUMMARY OF THE INVENTION

The present invention provides in one embodiment a method of transferring power throughout a vehicle system. Voltage measurements from a capacitor bank are received. These measurements are compared with a threshold voltage. A determination is made if the measurements are less than the threshold voltage. Instructions are transmitted to a battery to supply power to a plurality of coils of an integrated starter generator (ISG) motor. The plurality of coils are analyzed to determine if the plurality of coils are energized. Power is transmitted from the plurality of coils to the capacitor bank, if the plurality of coils are energized.

In another embodiment of the invention, there is a method of supplying power to a motor of a vehicle system from a capacitor bank. A determination is made if voltages of the bank are greater than a threshold voltage value. Power is provided from the capacitor bank to an ISG motor. Voltage from the capacitor bank is compared with voltage from a battery. A determination is made if voltages of the capacitor bank is equivalent to the voltage of the battery. Power is supplied from the battery to the ISG motor in conjunction with the capacitor bank supplying power to the ISG motor, if the voltage of the capacitor bank is equivalent to the voltage of the battery.

In yet another embodiment of the invention, there is a method of generating power in a vehicle system while the engine is in a brake mode. A determination if a vehicle system is in brake mode is made by measurements of a brake pedal and measurements of a vehicle speed sensor. Instructions are transmitted to initiate a regeneration mode in the ISG motor that produces a three phase voltage that is converted into a DC voltage. The DC voltage from the ISG motor is compared with a threshold voltage value that a battery can accept. A determination is made if the DC voltage from the ISG motor is greater than the threshold voltage value. DC voltage is supplied from the ISG motor to the capacitor bank if the DC voltage is greater than the threshold voltage value.

In another embodiment of the invention, there is a system for transferring power throughout a vehicle system. The system includes an integrated starter generator, an inverter controller, a half bridge circuit, a primary battery and a capacitor bank. The integrated starter generator (ISG) includes at least one coil operatively connected to the engine, where the ISG is capable of selectively operating as a motor for transmitting torque to the engine as a generator for generating electrical energy. The inverter controller includes a power inverter and a controller, where the inverter controller is operatively connected to the ISG. The half bridge circuit is operatively connected to the inverter controller. The capacitor bank is operatively connected to the half bridge circuit. The primary battery is operatively connected to the half bridge circuit. The controller compares measurements received from the capacitor bank, the half bridge circuit, the power inverter, the ISG and the primary battery with stored measurements to determine if the ISG should be supplied with power.

### BRIEF DESCRIPTION OF THE DRAWINGS

These and other advantages of the present invention that will become more fully apparent as the following description is read in conjunction with the accompanying drawings, wherein:

FIG. 1 depicts a block diagram of a vehicle system utilizing an integrated starter generator according to the preferred embodiment of the invention;

FIG. 2 depicts a block diagram of a vehicle system utilizing an integrated starter generator according to the preferred embodiment of the invention;

FIG. 3 depicts a graphic illustration of various components according to the preferred embodiment of the invention;

FIG. 4 depicts another graphic illustration of various components according to the preferred embodiment of the invention;

FIG. 5 depicts a flow chart according to the preferred embodiments of the invention;

FIG. 6a depicts another flow chart according to the preferred embodiment of the invention; and

FIG. 6b depicts a graphic illustration of the flow chart in FIG. 6a;

FIG. 7 depicts another flow chart according to the preferred embodiment of the invention.

### DETAILED DESCRIPTION OF THE PREFERRED EMBODIMENT

While traditional automotive electrical systems utilize a 14-volt power architecture, a new generation of vehicle electrical systems has switched to a 42-volt electrical systems, tripling existing vehicle voltage for both battery output (12 volts to 36 volts) and generator output (14-volt to 42-volt). The 42-volt stand has made possible the development and integration of additional technologies for vehicles, including an integrated starter generator that combines a starter motor and a generator function in one device.

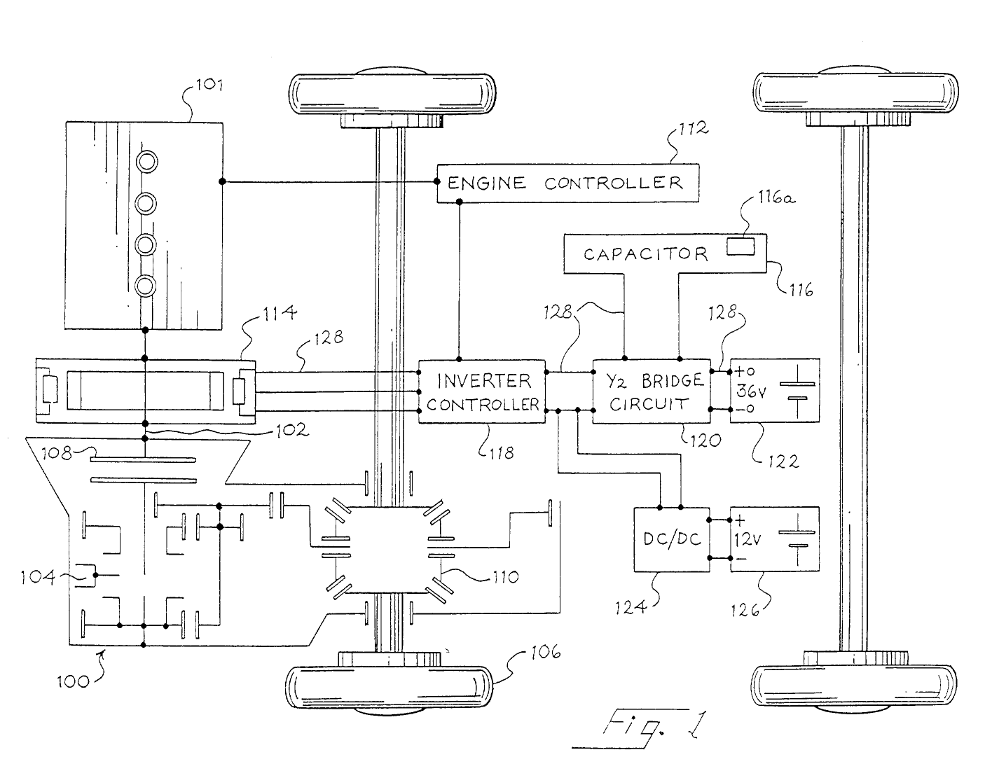

Referring now to the drawings, FIG. 1 is a schematic block diagram showing an overall vehicle system 100 utilizing a preferred embodiment of the present invention. The vehicle system 100 includes an engine 101 with an engine crankshaft 102, a transmission 104, a set of drive wheels 106, a coupling device 108, a differential gear mechanism 110, an engine controller 112, an integrated starter generator (ISG) 114, a capacitor bank 116, an inverter controller 118, a half bridge circuit 120, a 36 volt primary battery 122, a DC to DC converter 124, a second battery 126 and an inverter bus 128. The engine crankshaft 102 is coupled to the transmission 104 via the coupling device 108.

The inverter bus 128 operatively connects or electrically connects the ISG 114 to the inverter controller 118. Next, inverter controller 118 is operatively connected to the half bridge circuit 120. Capacitor bank 116 is also operatively connected to the half bridge circuit 120. Primary battery 122, in turn, is operatively connected to the half bridge circuit 120, as shown.

Engine 101 may be a conventional internal combustion engine disconnectably coupled to a manual transmission via a clutch mechanism or fluidly coupled to an automatic transmission via a torque converter. The transmission 104 is operatively connected to the drive wheels 106 through a differential gear mechanism 110 for transmitting the driving torque produced by the engine 101 to the drive wheels 106, as is well known in the art. Engine controller 112 preferably controls the operation of the engine 101.

The integrated starter generator (ISG) 114 can function either as an electric motor or as a generator that generates AC electric power for sourcing electric loads. The ISG 114 includes a stator having a winding that is bolted between the bell housing of the engine 101 and the transmission 104. Accordingly, the ISG 114 in a motoring mode may be energized to crank the vehicle engine 101 similar to a conventional electric motor before fueling of the engine begins to assist the torque output of the engine 101 after the engine is started.

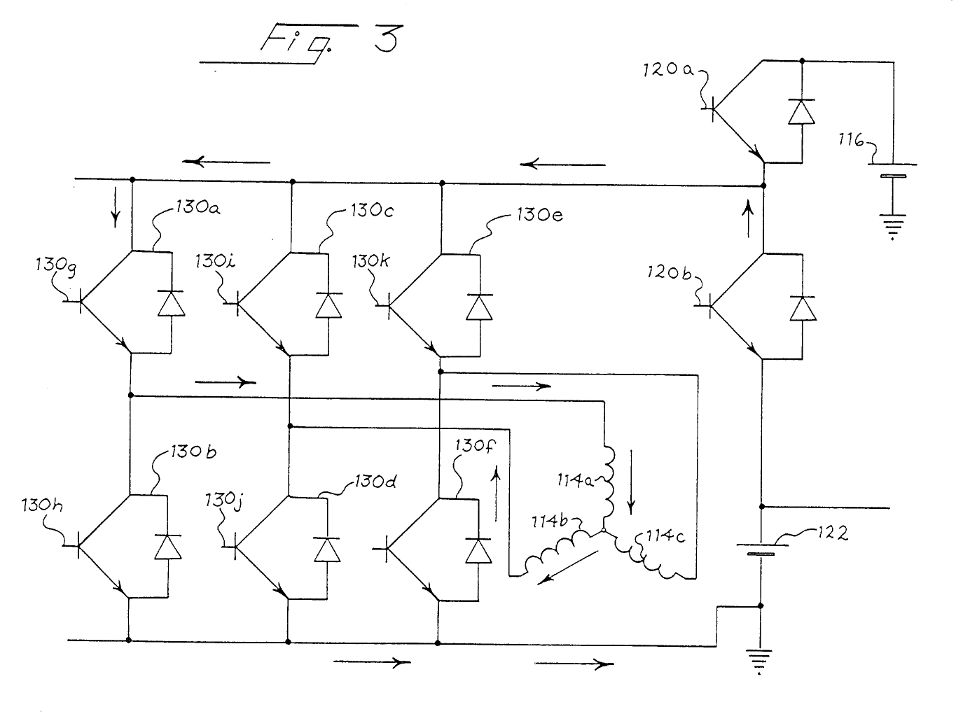

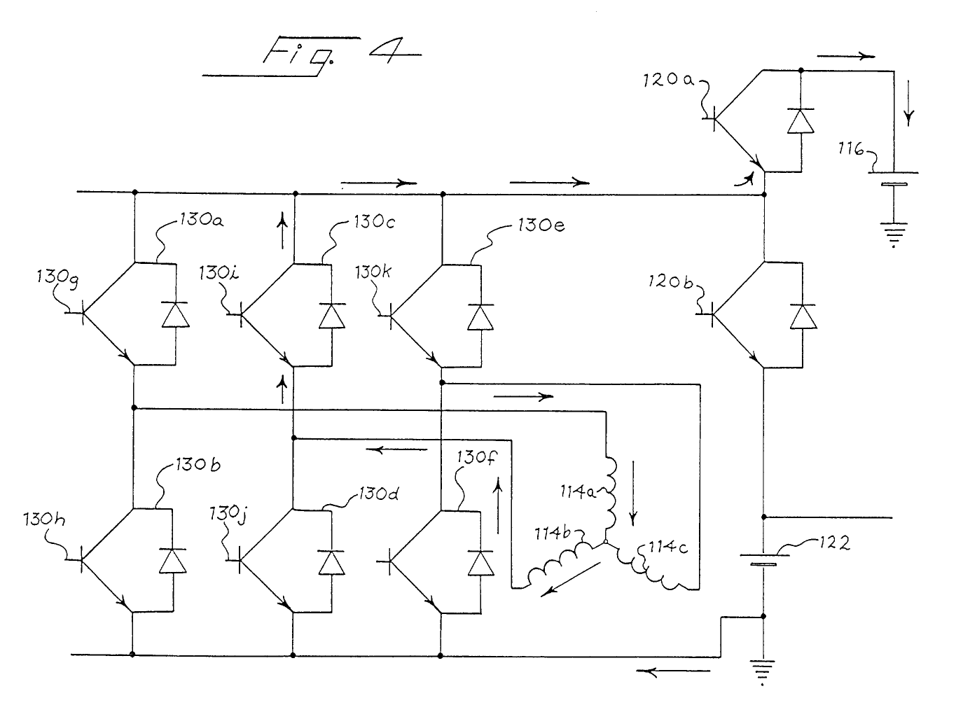

In the present embodiment, capacitor bank 116 is used to energize the ISG 114 to drive it as an electric motor. Only one capacitor is utilized, in the present embodiment, for the capacitor bank 116. There may, however, be a plurality of capacitors utilized in the capacitor bank 116. These capacitors may also have a variety of capacitance levels. The type and number of capacitors utilized is dependent on how much power or voltage the vehicle system requires. These capacitors may be operatively connected together in series and/or parallel. One configuration for the capacitor bank 116 that has been found useful is a capacitor module rated at 100 volts, 1-F capacitance from Pinnacle Research Institute Inc. of CA, USA. Referring to FIGS. 3 and 4, capacitor bank 116 is operatively connected to the half bridge circuit 120. The half bridge circuit includes a gate drive 120a and a gate drive 120b.

When the ultra capacitor is fully charged to about 100 volts, the capacitor provides 100-volt power sufficient to energize the ISG 114 sufficient to drive it as an electric motor to assist the torque output of the vehicle engine 101 when the engine is running under its own power. This ultra capacitor that may be utilized may be fully charged to about 100 volts and provide 100-volt power sufficient to power the ISG 114 to start the vehicle in adverse conditions.

In order to charge the capacitor bank 116, the primary battery 122 is provided. The primary battery is preferably a 36-volt battery and more preferably a 36-volt lead-acid battery of the type commonly used in 42-volt electrical vehicle systems, although other types of automotive batteries capable of driving the ISG 114 may be utilized. The primary battery 122 also powers the 42-volt bus electrical loads of the vehicle. The present embodiment also includes a second battery 126 preferably having a lower voltage capacity than the primary battery 122 and more preferably a 12-volt capacity. The battery 126 can power lower 14-volt loads traditionally found in automotive electrical systems.

The batteries 122 and 126 and the capacitor bank 116 can be recharged if needed through the generative and regenerative action of the ISG 114 in a generation mode selectively operating as a high voltage generator after the vehicle engine 101 has been started. The present embodiment includes the inverter bus 128 that includes electrical power lines connecting these components in order to transmit electrical energy between the ISG 114, the batteries 122 and 126 and the capacitor bank 116.

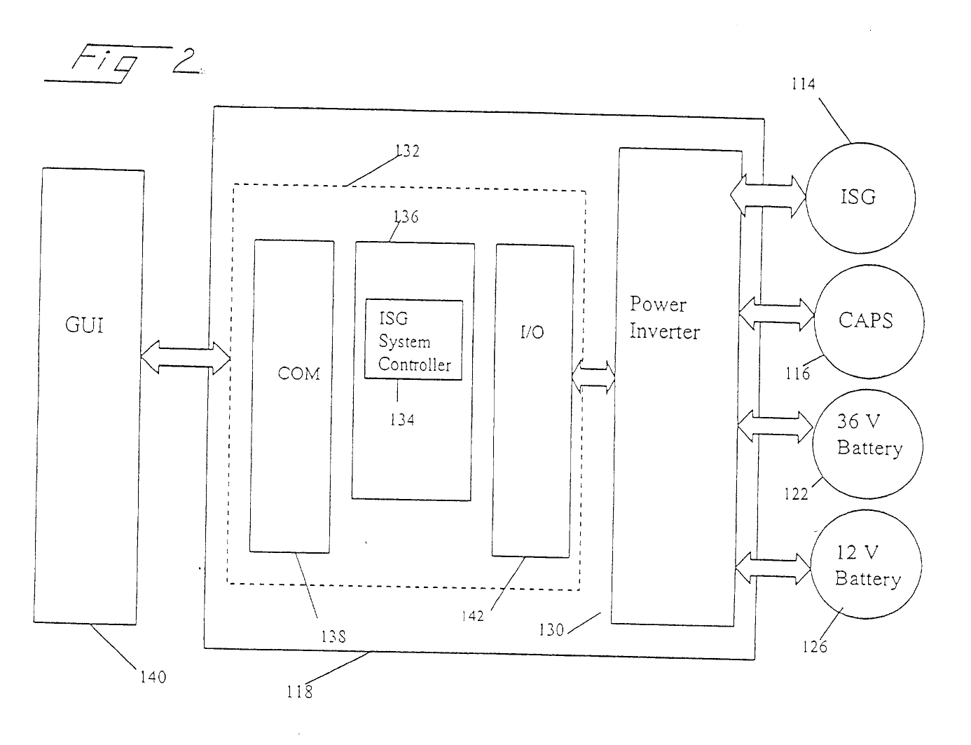

Referring to FIGS. 2, 3 and 4, the inverter controller 118 includes a power inverter 130 comprising a 3-phase bridge 130a-130f and gate driver circuits 130g-130l. Power inverter 130 is capable of inverting 100 volt DC power from the capacitor bank 116 into three-phase AC power for energizing the ISG 114 to drive it as an electric motor. In addition, when the ISG 114 functions as a generator, in the generation mode, the power inverter 130 rectifies the generated current by the ISG 114 into 100-volt DC power for charging the batteries 122 and the ultra capacitor in the capacitor bank 116.

The inverter controller unit 118 also includes a controller 132, as shown in FIG. 2. The controller 132 functionally implements an ISG system controller 134 for controlling the operation of ISG 114, interfaces with the engine controller 112 and sets various commands for the operation of the overall system, including commands such as charging the ultra capacitor in the capacitor bank 116 from coils 114a-114c of ISG 114. ISG system controller 134 also includes a software program that continuously monitors and reads measurements from electrical lines connected to various systems, sensors and components such as, for example, the capacitor bank 116, primary battery 122, ISG 114, brake pedal, power inverter 130, half bridge 120, and vehicle speedometer. These measurements have values indicative of voltages, currents and/or power. The software program is able to compare these values it receives from the electrical lines with stored measurements of voltages, currents, power values or specified voltage values for various components of the vehicle 100 such as, for example, the capacitor bank 116, the primary battery 122, power inverter 130, the half bridge circuit 120 and ISG 114. The software program may also utilize sensors that act as the electrical lines to obtain measurements of voltage, current and/or power values for various portions of the vehicle 100 such as the capacitor bank 116 sensor 116a.

Preferably, the controller 132 includes a high-performance floating-point digital signal processor 136 that executes control logic for implementing the functionality of the ISG system controller 134. One digital signal processor (DSP) that has been found to be useful is the 16-bit fixed point DSP model TMS340F243 from Texas Instruments. Controller 132 also desirably includes a communication processor 138 that performs tasks for debugging and testing the control algorithms implemented on DSP 136. The communication processor 136 allows an operator to use a graphical user interface (GUI) 140 to communicate with the controller 132 during testing and debugging of the control algorithms.

The controller 132 further includes an input/output (I/O) module 142, such as a programmable logic device or programmable array logic, to off load some of the computational work performed by the digital signal processor 136. Digital signal processor 136 issues commands to the ISG 114 and the engine controller 112 through the I/O module 142. The I/O module 142 also receives measurements from the electrical lines from various portions of the vehicle, as described above, where these measurements are then sent to the software program and the digital signal processor 136 for processing. Those of ordinary skill in the art recognize that the controller 132 alternatively may utilize other types of microprocessors or computers with sufficient processing capabilities and alternative interface hardware to implement the system controller 134 through algorithms or hardwired control logic.

FIGS. 3 and 4 are a graphical illustration of a circuit that represents the connection of the various components in accordance with the presently preferred embodiment. In these Figures, gate drives 130g-130l and 3 phase half-bridges 130a-130f connected in series and parallel are included in the power inverter 130. Power inverter 130 can invert 100 volt DC power from the capacitor bank into three-phase AC power for energizing the motor coils 114a-114c of ISG 114. The power inverter 130 is operatively connected through inverter bus 128 to motor coils 114a-114c of ISG 114. Inverter bus 128 operatively connects half bridge circuit 120 to capacitor bank 116. In addition, inverter bus 128 also operatively connects battery 122 to a 42 volt bus protection limit. The 42 volt bus protection limit serves to protect the components of the circuit from being damaged when there is a high energy spike.

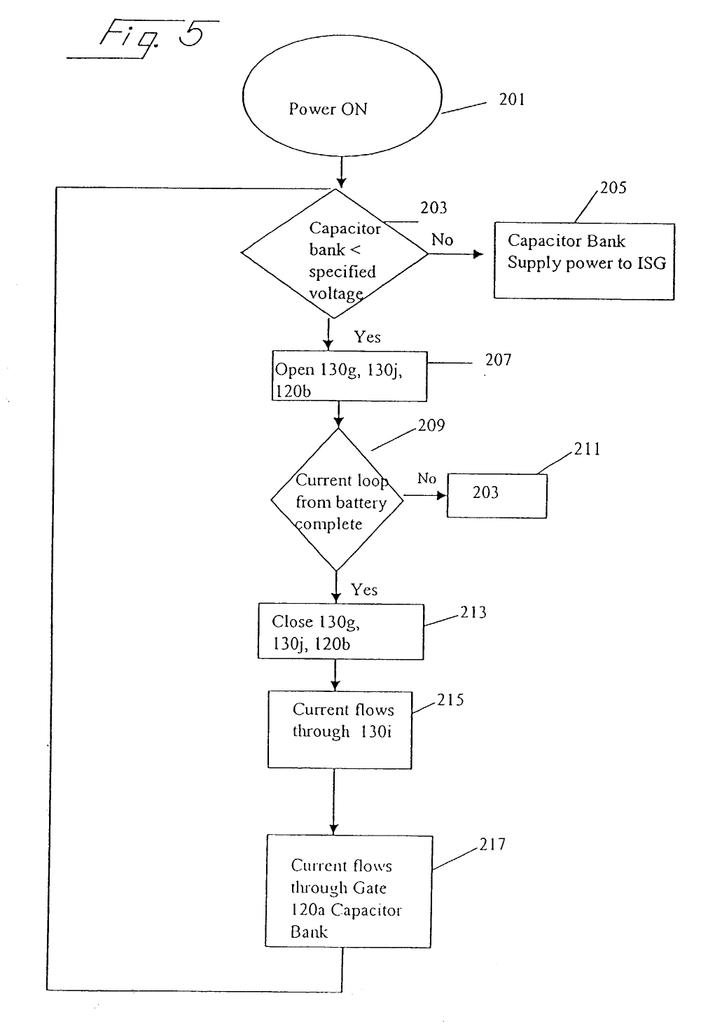

FIG. 5 is a flow chart illustrating another embodiment of the invention. In 201, an operator of the vehicle system starts the vehicle by inserting an ignition key and turning it to an ON position. At that point, the power inverter 130, the capacitor bank 116 and the ISG motor 114 are powered up. When the capacitor bank 116 is powered up the electrical lines electrically connected to the sensors on capacitor bank 116 and DSP 136 transmit measurements indicative of voltage, current and/or power values of the capacitor bank 116 to the software program of DSP 136. DSP 136 receives these measurements from the electrical lines electrically connected to the capacitor bank 116. In 203, based on the values of the measurements the software program of controller 132 determines if the capacitor voltage value is less than a specified voltage value stored in the DSP 136, when the controller 132 compares the received measurements with the threshold voltage. The specified voltage value or a threshold voltage value may be a 42 volt value from the inverter bus, a motor voltage of 62 volts, a voltage higher than the battery voltage or any other voltage value.

If the controller 132 determines that the voltage from the capacitor bank 116 is not less than the threshold voltage in 205, then controller 132 instructs the capacitor bank 116 to supply power to the ISG motor 114 to charge the capacitor bank. Controller 132 communicates with the I/O module 142 to instruct the capacitor bank 116 to supply power or voltage through the inverter bus128 to excite the coils 114a-114c of the ISG 114.

If the controller 132 determines that the capacitor bank 116 voltage is less than the threshold voltage in 207, then controller 132 instructs the primary battery 122 to supply power or voltage to the ISG motor 114. Controller 132 through the I/O module 142 instructs the battery 122 to supply power or voltage through the inverter bus 128 to a plurality of coils 114a-114c to energize or excite these coils. In order to energize the coils 114a-114c of the ISG 114, the controller 132 opens the gate driver circuits 130g and 130j of the power inverter 130 and gate switch 120b of the half bridge circuit 120, as shown in FIG. 3 by arrows, then the battery 124 transmits voltage through the 42 volt bus to the inverter bus 128 to 130g, 130j and 120b. The current from gate 130g flows through the coils 114a-114b and flows out through gate 130j and 120b.

In 209, there is a determination by the controller 132 as to whether all of the current from gate drive circuit 130g has flowed through coils 114a-114b and through gates 130j and 120b. Thus, there is an analysis to determine if the plurality of coils are energized. There are electrical lines, as described above, that electrically connects or are connected to sensors (not shown) on the coils 114a-114c to DSP 136. These electrical lines provide current measurements for coils 114a-114c that are analyzed by controller 132 so that controller 132 can determine if the currents flowed through 114a-114b. If controller 132 determines from these measurements that the currents have not flowed through coils 114a-114b, then the controller 132 returns, in 211, to 203.

In 213, if the controller 132 determines from the measurements that all the current has traveled through 114aand 114b, then gates 130g, 130j and 120a are closed. In 215, the current flows through a diode of gate 130h to the inverter bus 128. In 217, since the voltage on the inverter bus 128 is higher than the capacitor voltage, a diode of gate 120a allows the current to flow through it to charge the capacitor bank 116. Thus, power is transmitted from the coils 114a-114b to capacitor bank 116. Then, the process returns to 203 until the voltage of the capacitor bank 116 is above the threshold voltage. Controller 132 compares the voltage of the capacitor bank 116 with the threshold voltage to determine if the voltage of the capacitor bank 116 is greater than the threshold voltage. When controller 132 determines that the capacitor voltage is above the threshold voltage, then the capacitor bank 116 is instructed by the controller 132 through I/O module 142 to supply power or voltage through the inverter bus 128 to the ISG 114.

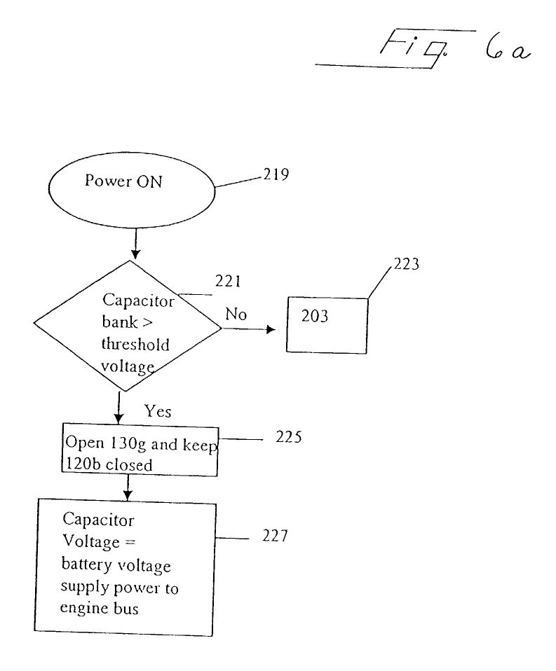

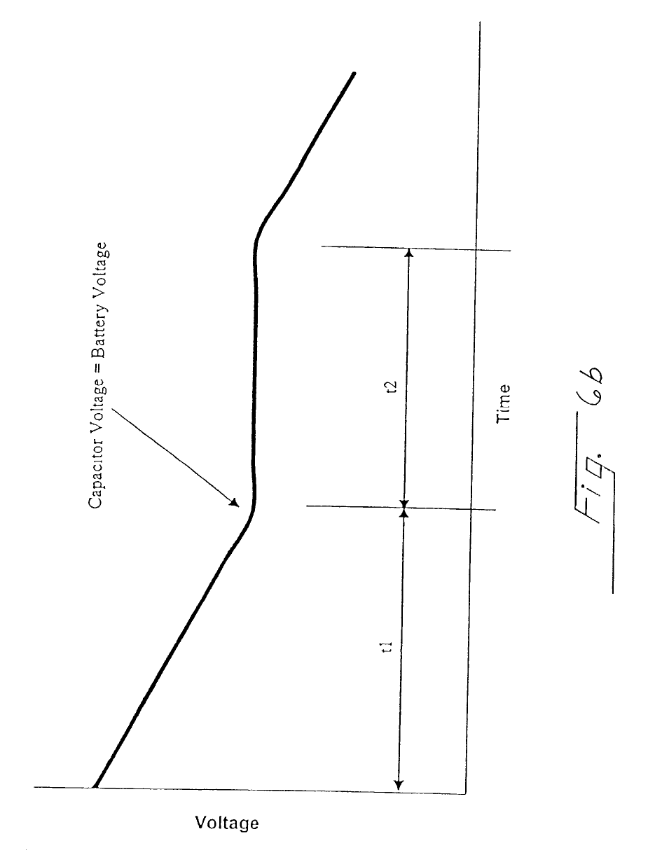

FIG. 6a is a flow chart illustrating another embodiment of the invention. In 219, an operator of the vehicle system starts the vehicle as described above. When the capacitor bank 116 is powered up, the electrical lines electrically connected to the capacitor bank 116 and DSP 136 transmit measurements indicative of voltage, current and/or power values of the capacitor bank 116 to the software program of DSP 136. DSP 136 receives these measurements indicative of voltage, current and/or power values from the electrical lines as described above. In 221, based on these measurements the controller 132 determines if the capacitor bank 116 voltage is greater than a threshold voltage value stored in the controller 132, when the controller 132 compares the received the measurements indicative of voltage with the threshold voltage value. The threshold voltage value is equivalent to the specified voltage value described above.

If the controller 132 determines that the voltage from the capacitor 116 is not greater than the threshold voltage, then, in 223, the controller 132 advances to 203. If the controller 132 determines that the voltage from the capacitor bank 116 is greater than the threshold voltage, then, in 225, the controller 132 instructs capacitor bank 116 to supply power to the inverter bus 128. Controller 132 utilizes I/O module 142 to instruct the gate 130g to open and gate 120b to close. Power or voltage is supplied from the capacitor bank 116 by opening gate 122a to supply and/or provide power or voltage to the ISG motor 114. At this point, the electrical lines at the capacitor bank 116 and the battery 122 are receiving measurements that are transmitted to the controller 132.

Typically, the power voltage from the capacitor bank 116 is higher than the voltage from the battery 122, so the capacitor bank 116 supplies voltage or power to the ISG motor 114 instead of battery 122. The controller 132 continually compares the measurements from the capacitor bank 116 with the measurements from the battery 122 to determine if the power or voltage from the capacitor bank 116 are equivalent to measurements from the battery 122. In 227, when the controller 132 determines that the measurements from the capacitor bank 116 are equivalent to the measurements from the battery 122, then the controller 132 instructs the capacitor bank 116 and battery 122 to supply power or voltage to the ISG motor 114. Controller 132 instructs a diode gate drive 120b to conduct and supply power from the battery 122 through the inverter bus 128 to the ISG motor 114 in conjunction with the capacitor 116 supplying power or voltage to the ISG motor 114.

FIG. 6b is a graphical illustration of the flow chart described in FIG. 6a During a time duration t1, capacitor bank 116 is supplying the power to the motor coils 114a-114c. This time duration t1 may be for a short period of time or a long period of time depending on the number and capacitance levels of the capacitors in the capacitor bank. For instance, if there is one capacitor in the capacitor bank 116 the duration t1 will be for a short period of time. If there are two or more capacitors in the capacitor bank 116, then the duration t1 will be for a longer period of time. The duration t1 varies because it typically requires more time for three capacitors to generate 300 volts rather than one capacitor generating 100 volts to drop to a 36-42 volt level of the battery 122. When the voltage from the capacitor in the capacitor bank 116 does drop down to a 36-42 volt level of the battery 122, then, in duration t2, the battery 122 in conjunction with the capacitor bank supplies power or voltage to the ISG motor as shown by t2

Thus, the capacitor bank 116 is charged during an initial stage of operating the vehicle 100. In an initial stage of operation, the performance of the ISG 114 is increased by utilizing the higher voltage of the charged capacitor bank 116 to supply power to a motoring mode of the ISG 114. Performance of the ISG 114 in the motoring mode is further enhanced by later adding a power supply from the battery 122 to work in conjunction with capacitor bank 116 to supply power to the ISG 114 motor. The duration of power supply to the ISG 114 is increased and there is an assurance of the initial operation of engine 101. By using capacitor bank 116 for pulsation power and battery 122 for duration power, this strategy helps to optimize the battery 122 and capacitor bank 116 for energy level, power level, size and weight. This embodiment also enables the ISG motor 114 to be driven for a longer duration than is possible with only ultra capacitors in capacitor bank 116.

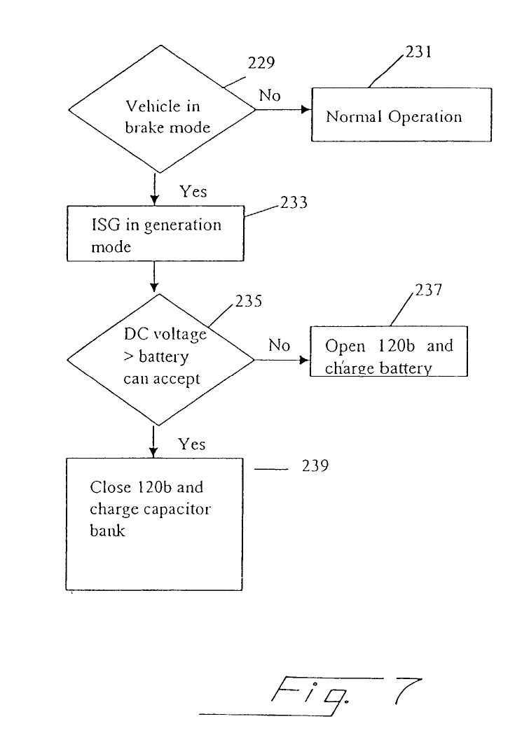

FIG. 7 is a flow chart illustrating another embodiment of the invention. At this point, the operator has turned the vehicle ON and the vehicle has been running for a period of time and the ISG 114 is in a generating mode. In 229, an operator of the vehicle system puts the vehicle in a brake mode, by pressing on a brake pedal of vehicle 100. The brake pedal includes electrical lines that transmit measurements indicative of a length of time to the software program of controller 132. In addition, there is a vehicle speed sensor that transmits measurements indicative of speed such as miles per hour or kilometers per hour through the I/O module142 to controller 132 when the brake pedal is depressed. The vehicle speed sensor may include electrical lines connected between the speedometer and the controller. Controller 132 reads the measurements from the electrical lines of the brake pedal and the vehicle speed sensor and compares it with a stored measurement for the brake pedal and a stored measurement for the vehicle speed to determine if the vehicle 100 is in a brake mode. For instance, the standard measurement for the brake mode may include: the brake pedal must be pressed for at least 0.5 seconds and the vehicle speed must be less than 10 miles per hour. In, 231, if the measurements from the brake pedal reveal that the brake pedal has been pressed for under 0.5 seconds and the vehicle speed is over 10 miles per hour, then the controller 132 instructs the vehicle 100 and/or ISG motor 114 to maintain normal operation.

In 233, if the measurements from the brake pedal reveal that the brake pedal has been pressed for over 0.5 seconds and the vehicle speed is less than 10 miles per hour, then the controller 132 determines that vehicle 100 is in the brake mode. Controller 132 instructs ISG motor 114 to initiate a regeneration mode. ISG motor 114 in the regeneration mode transmits a three phase voltage or power to the power inverter 130, then the power inverter converts the voltage into a DC voltage.

In 235, controller 132 compares the DC voltage with a threshold voltage of what the battery can accept. The threshold voltage of what the battery 122 can accept is known to the controller 132 based on the electrical lines, as described above, that electrically connects the software program and DSP 136 to the battery 122. The software program and DSP 136 continuously monitors the measurements of battery 122 and is able to ascertain the amount of threshold voltage the battery 122 can accept. Controller 132 determines if the DC voltage is greater than this threshold voltage. In 237, if the DC voltage is not greater than this threshold voltage, then controller 132 instructs the gate drive 120b to open and instructs the ISG 114 motor to transmit the voltage through the inverter bus 128 to the battery 122. Thus, the DC voltage may provide some voltage to battery 122 and capacitor bank 116. In another embodiment, if it is determined beforehand that the battery 122 can not handle the voltage or power from the ISG 114 motor, then 120b remains closed and the controller 132 immediately instructs ISG 114 motor to transmit the voltage to the capacitor bank 116. Thus, battery 122 is not able to receive any DC voltage from the ISG motor 114.

In 235, if this DC voltage is greater than this threshold voltage value, then controller 132, in 239, instructs the ISG 114 motor to supply power or voltage to the capacitor bank 116. Controller 132 instructs the gate drive 120b to close and commands the ISG 114 to transmit voltage through the inverter bus 128 through gate 120a to the capacitor 116. This will help in protecting the components on the bus from getting damaged due to high-energy spike.

Thus it is intended that the foregoing detailed description be regarded as illustrative rather than limiting and that it be understood that it is the following claims, including all equivalents, which are intended to define the scope of the invention.

We claim:

1. A method of transferring power throughout a vehicle system, the method comprising:
receiving voltage measurements from a capacitor bank;
comparing the measurements with a threshold voltage;
determining if the measurements are less than the threshold voltage;
transmitting instructions to a battery to supply power to a plurality of coils of an integrated starter generator (ISG) motor;
analyzing the plurality of coils to determine if the plurality of coils are energized; and
transmitting power from the plurality of coils to the capacitor bank, if the plurality of coils are sufficiently energized.

2. The method of claim 1, wherein comparing the measurements with the threshold value is performed by a digital signal processor.

3. The method of claim 1, wherein transmitting instructions to the battery to supply power to the plurality of coils of the ISG motor is performed by a controller.

4. The method of claim 1, wherein the plurality of coils do not utilize a DC/DC converter to transmit power to the capacitor bank.

5. A method of supplying power to a motor of a vehicle system from a capacitor bank, the method comprising:
determining if voltages of a said bank are greater than a threshold voltage value;
providing power from the capacitor bank to an ISG motor;
comparing a voltage of the capacitor bank with a voltage of a battery;
determining if voltage of the capacitor bank is equivalent to the voltage of the battery; and
supplying power from the battery to the ISG motor in conjunction with the capacitor bank supplying power to the ISG motor, if the voltage of the capacitor bank is equivalent to the voltage of the battery.

6. The method of claim 5, wherein a digital signal processor receives measurements from the capacitor bank.

7. The method of claim 6, wherein the digital signal processor transmits instructions to a controller to supply power from the capacitor bank to the ISG motor.

8. The method of claim 6, wherein the digital signal processor determines if the voltage of the capacitor bank is equivalent to the voltage of the battery.

9. The method of claim 5, wherein the capacitor bank includes at least one ultra capacitor.

10. A method of generating power in a vehicle system while the engine is in a brake mode, the method comprising:
determining from measurements of a brake pedal and measurements from a vehicle speed sensor, if the vehicle system is in the brake mode;
transmitting instructions to initiate a regeneration mode in the ISG motor that produces a three phase voltage that is converted into a DC voltage;
comparing the DC voltage from the ISG motor with a threshold voltage value that a battery can accept;
determining if the DC voltage from the ISG motor is greater than the threshold voltage value; and
supplying DC voltage from the ISG motor to the capacitor bank, if the DC voltage is greater than the threshold voltage value.

11. A system for transferring power throughout a vehicle system, the system comprising:
an integrated starter generator (ISG) having at least one coil operatively connected to the engine, wherein the ISG is capable of selectively operating as a motor for transmitting torque to the engine as a generator for generating electrical energy;
an inverter controller having a power inverter and a controller, wherein the inverter controller is operatively connected to the ISG;
a half bridge circuit operatively connected to the inverter controller;
a capacitor bank operatively connected to the half bridge circuit; and
a primary battery operatively connected to the half bridge circuit,
wherein the controller compares measurements received from the capacitor bank, the half bridge circuit, the power inverter, the ISG and the primary battery with stored measurements to determine if the ISG should be supplied with power.

12. The system of claim 11, wherein the controller includes a digital signal processor.

13. The system of claim 11, wherein the digital signal processor receives the measurements then compares the measurements with the stored measurements, then instructs the controller to supply power to the ISG.

14. The system of claim 11, wherein the controller determines based on the received measurements compared with the stored measurements if the capacitor bank should be supplied with power.
